(19) United States
(12) Patent Application Publication
(10) Pub. No.: US 2023/0155704 A1
(43) Pub. Date: May 18, 2023

(54) GENERATIVE WIRELESS CHANNEL MODELING

(71) Applicant: QUALCOMM Incorporated, San Diego, CA (US)

(72) Inventors: Tribhuvanesh OREKONDY, Biel (CH); Arash BEHBOODI, Amsterdam (NL); Joseph Binamira SORIAGA, San Diego, CA (US); Max WELLING, Bussum (NL)

(21) Appl. No.: 18/054,896

(22) Filed: Nov. 12, 2022

Related U.S. Application Data
(60) Provisional application No. 63/278,898, filed on Nov. 12, 2021.

(51) Int. Cl. H04B 17/391; H04L 41/16; H04L 41/14; H04B 17/309

(52) U.S. Cl. CPC H04B 17/3912; H04L 41/16; H04L 41/145; H04B 17/309

(57) ABSTRACT

Certain aspects of the present disclosure provide techniques for wireless channel modeling. A set of input data is received for data transmitted, from a transmitter, as a signal in a wireless channel. A channel model is generated for the wireless channel using a generative adversarial network (GAN). A set of simulated output data is generated by transforming the first set of input data using the channel model.

### CROSS-REFERENCE TO RELATED APPLICATIONS

This Application claims the benefit of and priority to U.S. Provisional Patent Application No. 63/278,898, filed on Nov. 12, 2021, the entire contents of which are incorporated herein by reference.

### INTRODUCTION

Aspects of the present disclosure relate to wireless channel modeling (e.g., modeling or estimating the medium through which wireless communications are transmitted).

In many conventional systems, wireless channel modeling is driven by collecting field measurements using specialized equipment, making assumptions of the propagation medium, and carefully estimating the model parameters. These steps make modeling the channels a time-consuming process that demands significant domain expertise.

Additionally, wireless channels are conventionally modeled as a linear system. In some such systems, the intricacies of propagation channels are (approximately) captured mainly through a cluster of channel taps with their gains and delays. Generally, such conventional channel models are standardized models that, though widely used for evaluation of wireless communication scenarios, have inherent inaccuracies and inefficiencies. For example, these conventional models rely on certain abstractions and simplifications, such as pre-defined delay profiles with stochastic channel gains.

In conventional systems, it is cumbersome or impossible to build a channel model from field data measured in an environment. Some current methods operate based on selecting a channel model and fitting the parameters to the measured data, but this process is not automated and involves manual engineering. Additionally, although the linearity assumption is in itself generally adequate or reasonable, the received signal in practice undergoes non-linear effects due to things such as the quantization effect, amplifier saturation, and hardware imperfections. Further, the self-interference in full duplex channels serves as another deviation from a linearity assumption.

Finally, conventional models are generally not differentiable, which makes these models problematic for end-to-end neural network designs, as certain optimization methods, such as back-propagation, call for end-to-end differentiable architectures.

Accordingly, techniques are needed for improved wireless channel modeling.

### BRIEF SUMMARY

Certain aspects provide a method of generating simulated output data, comprising: receiving a first set of input data for data transmitted, from a transmitter, as a signal in a wireless channel; generating a channel model for the wireless channel using a generative adversarial network (GAN); and generating a first set of simulated output data by transforming the first set of input data using the channel model.

Certain aspects provide a method of training a channel model, comprising: receiving a set of wireless measurements corresponding to a wireless signal, comprising: a first set of input data for data transmitted as a wireless signal, and a first set of output data for the wireless signal when received; and training a generative adversarial network (GAN), based on the set of wireless measurements, to generate a channel model for the wireless signals, wherein the channel model can be used to simulate output data based on input data.

Other aspects provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of the one or more aspects and are therefore not to be considered limiting of the scope of this disclosure.

FIG. 1 depicts an example wireless environment for channel modeling according to some aspects of the present disclosure.

FIG. 2 depicts an example workflow for training a generator model to enable wireless channel modeling.

FIG. 3 depicts an example workflow for predicting output data characteristics using a generated channel model.

FIG. 4 depicts an example flow diagram illustrating a method for training a generative adversarial network for improved channel modeling.

FIG. 5 depicts an example flow diagram illustrating a method for generating a channel model using a generator model.

FIG. 6 depicts an example flow diagram illustrating a method for classifying output data using a discriminator model.

FIG. 7 depicts an example flow diagram illustrating a method for generating simulated output data using a channel model.

FIG. 8 depicts an example flow diagram illustrating a method for generating simulated wireless data using a machine learning model.

FIG. 9 depicts an example flow diagram illustrating a method for training a machine learning model for channel modeling.

FIG. 10 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for improved wireless channel modeling.

In some aspects, to address the conventional challenges and enable rapid channel modeling with low overhead, a data-driven approach is used to learn wireless channel models from collected measurements (e.g., on device). In some aspects, the simulation system does so by leveraging a generative adversarial network (GAN), which enables the model to learn a distribution over stochastic wireless channels (e.g., single-input single-output (SISO) channels, multiple-input single-output (MISO) channels, single-input multiple-output (SIMO) channels, and multiple-input multiple-output (MIMO) channels) from observed measurements. In at least one aspect, the model can implicitly model the MIMO channel as a distribution of time-domain band-limited impulse responses, thereby making the channel invariant to certain input configuration changes (enabling the model to simulate data accurately even when the input configuration differs from the data used during training). For example, the model may be used to accurately simulate any number of orthogonal frequency-division multiplexing (OFDM) subcarriers, cyclic prefix (CP) lengths, and the like, regardless of what these parameters were set to during training.

It is generally not trivial to model complex communication channels using various machine learning architectures given the complexity of the design choices made to develop and train these architectures. Conventional approaches are not tractable for use in various modern estimation and detection processes. For example, in modern communication systems, using techniques like OFDM, channels are parametrized mostly by a linear transformation which avoids inference directly over the parameters of the channel. Additionally, with growing dimensionality of the channel (such as in massive MIMO systems) or with increasing complexity of the modeling, the simulation or inference phase becomes signficantly more time consuming, rendering conventional approaches impractical for many deployments.

In some aspects of the present disclosure, the wireless channel is represented using its conditional distributions, enabling inclusion of a variety of nonlinear effects. In some aspects, this conditional distribution is learned using a GAN that can model complex (and not necessarily linear) channels. In an aspect, the GAN includes a deep neural network (DNN)-based generative model. During training, the objective for the GAN may be to train a DNN model that captures the distribution of some observed input data, allowing one to sample new datapoints. In some GAN aspects, this is achieved by leveraging two machine learning models (e.g., DNNs): a generator which transforms a random noise vector (e.g., drawn from an isotropic Gaussian distribution) into a sample of the target distribution, and a discriminator which predicts whether a given sample was generated by the generator (e.g., considered “fake”) or is a sample from the actual target distribution (e.g., considered “real”). The two models (generator and discriminator) may be trained simultaneously using one or more min-max objectives

In at least one aspect, the generator of the GAN is trained to generate a channel model (e.g., represented as a three-dimensional tensor), which can then be combined with input data (e.g., the data transmitted from a transmitter in the wireless channel) to yield simulated or predicted output data (e.g., the data output from the wireless channel and subsequently received by a receiver). In an aspect, the discriminator of the GAN is similarly trained to classify data as either real (e.g., true output data in a wireless system) or simulated/fake (e.g., data generated using the channel model). These two components can then be used to iteratively train each other, leading to a generator network that can produce accurate and robust channel models.

In some aspects, as this channel model is produced using a neural network (e.g., the generator network of a GAN), the channel model can be used to generate simulations using parallelization, enabling vastly improved efficiencies and reduced latency when generating predicted or simulated data. Further, the model enables back-propagation through the model, and inference over its parameters. As the model can be learned systematically using gradient-descent-based methods, its neural realization makes the model scalable to higher dimensions.

In some aspects, the model can be trained to efficiently represent MIMO channels (e.g., where the number of transmitter and receiver antennas are both greater than one), while conventional systems fail to enable such ability. Further, due to the proposed architecture, the simulation system can often use low-resolution measurements (e.g., less than 100 MHz bandwidth), enabling use on limited devices and with limited data.

Beneficially, the learned channel models generated using aspects of this disclosure exhibit statistics (e.g., impulse and frequency responses) that are similar to the underlying wireless channel, allowing the channel model to be used to effectively predict, simulate, or otherwise estimate the impact of the channel on the transmitted data. This rapid, accurate, and efficient wireless modeling can enable a wide variety of significantly improved techniques and solutions, such as improved management and configuration of transmitting and receiving devices, resulting in improved wireless communications.

### Example Environment for Wireless Channel Modeling

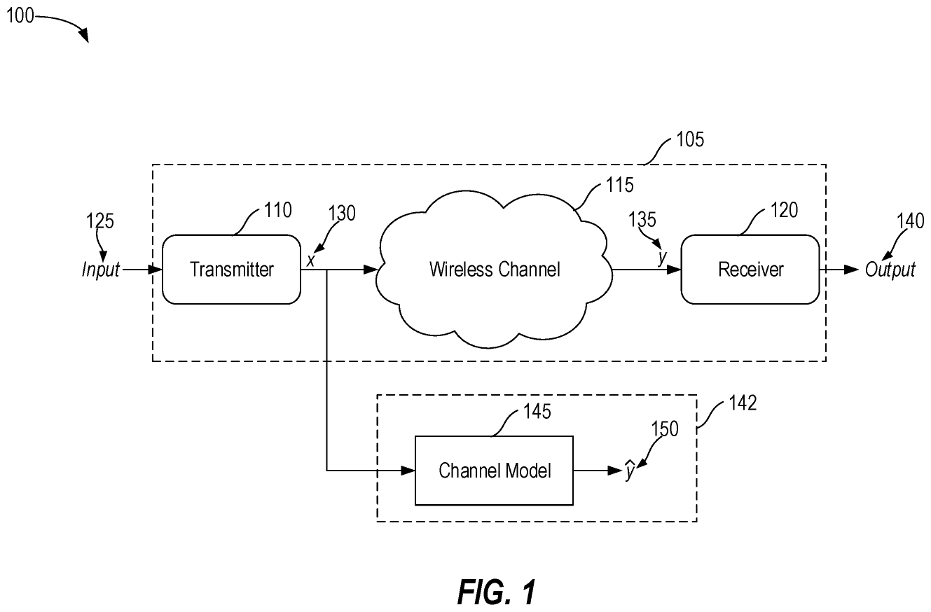

FIG. 1 depicts an example wireless environment 100 for channel modeling according to some aspects of the present disclosure.

In the illustrated example, a wireless physical layer 105 exists connecting a transmitter 110 and receiver 120 via a wireless channel 115. Generally, the transmitter 110 is configured to transmit data via a wireless signal (e.g., through the wireless channel 115) to the receiver 120. The receiver 120, in turn, is configured to receive the data via the wireless signal. Although the illustrated example depicts a single transmitter 110 and a single receiver 120, there may be any number of transmitters and receivers in the environment 100. Additionally, each transmitter 110 and receiver 120 may include any number of antennas (which may enable MIMO communications).

Further, though a discrete transmitter 110 and receiver 120 are depicted, in some aspects, the transmitter 110, receiver 120, or both may configured to both transmit and receive data (e.g., each acting as a transceiver). In aspects, the wireless physical layer 105 may correspond to any number of wireless technologies, including a wireless local area network (WLAN) such as Wi-Fi, a cellular connection (such as 4G, 5G, etc.), and the like. In some aspects, the transmitter 110 and receiver 120 communicate via a MIMO signal. For example, the transmitter 110 and/or receiver 120 may have multiple antennas, enabling data to be transmitted along multiple transmission paths or links in the wireless channel 115.

As illustrated, the transmitter 110 receives an input data 125 (e.g., a series of bits in a communication), and transmits a corresponding set of input signal 130 (labeled “x” in the depicted example). In some aspects, the input signal 130 is referred to as input data, as this signal is used as input to the wireless channel 115. In some aspects, the input signal 130 may alternatively be referred to as transmitted data. In some aspects, the input signal 130, represented as x, corresponds to the input data 125, encoded according to the transmission protocol being used. For example, x may be a MIMO signal representing the input data 125.

In an aspect, the wireless channel 115 may modify, transform, or otherwise affect the transmitted signal in a variety of ways due to physical realities of the space and/or the antennas of the transmitter 110 and receiver 120, such as interference in the channel, signal noise, antenna imperfections, attenuation, signal reflection, and the like. As a result, the initial input signal 130 is transformed, by the wireless channel 115, into an output signal 135 (labeled “y” in the illustrated example). That is, the characteristics of the output signal 135 that is actually received at the receiver 120 may differ in various ways from the characteristics of the originally transmitted input signal 130. In some aspects, the output signal 135 may alternatively be referred to as output data and/or received data. In some aspects, the receiver 120 may be configured to receive the output signal 135, and decode the received output signal to retrieve the original data, outputting the decoded signal as output 140. In some aspects, the output 140 may match the input data 125.

In a wide variety of environments, the particular characteristics of the wireless channel 115 can drive a number of configuration choices for the wireless communication channel. For example, the transmitter 110 and/or receiver 120 may be configured to use different communication parameters depending on the noise level of the wireless channel 115, impulse and frequency response of the wireless channel 115, and the like (e.g., to use more robust parameters in some aspects, or to use less robust parameters that provide higher throughput in others). In conventional systems, this is often a largely manual, imprecise, static, and/or intermittent process, involving significant effort and often resulting in inefficiencies.

As discussed above, some efforts have been made to enable more accurate modeling of the wireless channel 115. Channel models may be able to improve the communications, if such channel models can be used to reliably, accurately, and quickly predict the characteristics of the output signal 135. However, as discussed above, conventional models generally fail to account for various aspects of the channel (such as nonlinearity), and are generally too slow to be used in real time transmissions. Further, conventional techniques generally cannot be performed on-device (e.g., on a user equipment, such as a smartphone).

In aspects of the present disclosure, a channel model 145 is constructed, using a GAN, to represent the wireless channel 115. In some aspects, the channel model 145 is generated and/or used by a simulation system 142, which may or may not be the same system that trained the underlying GAN. Though depicted as a discrete component for conceptual clarity, in some aspects, the simulation system 142 can generally be implemented using a variety of devices or components, including on the transmitter 110, on the receiver 120, on a third device, in the cloud, and the like.

Generally, the channel model 145 is generated by processing some latent input (e.g., a probability distribution) with a trained generator, as discussed in more detail below. In some aspects, the generator is conditioned using antenna indices (e.g., using each pair of receiving and transmitting antennas), enabling fine-grained representation of MIMO channels.

In aspects, rather than explicitly learning input-output relationships between input signal 130 and output signal 135, the channel model 145 is generated based on learned implicit relations. That is, rather than explicitly modeling the input-output relationship for a given wireless system, the model implicitly models the distribution of stochastic channel effects using a generator, enabling the simulation system 142 to generalize in that it can accurately predict output data even when the configurations of the communications system differ. Generally, by using a discriminator network in the GAN, the generator learns to model these distributions. In some aspects, if other approaches were used (such as cross-entropy loss between the simulated data and the true data), then the space may be flattened into a single solution that corresponds to the specific input-output relationship, thereby reducing generalization and adaptability.

The channel model 145 can generally be created and used rapidly and efficiently, enabling real time (or near real time) predictions to be generated for the input signal 130. In aspects, the channel model 145 may be deployed on the transmitter 110, on the receiver 120, on a third device (e.g., in the cloud), or on multiple devices. As illustrated, the input signal 130 can be processed using the channel model 145 to yield simulated output signal 150 (labeled “y”). In some aspects, this simulated output signal 150 may alternatively be referred to as simulated or predicted output data, or predicted or simulated received data.

In some aspects, the channel model 145 can model the channel as ŷᵢ=Σⱼ₌₁^{N}^{_{T}} h_{i,j}(τ)*xⱼ, i=1,2, . . . , ŷᵢ, where yt is the output data received on antenna i, j is a transmitting antenna index, N_{T} is the number of transmitting antennas, N_{R} is the number of receiving antennas, h_{t,j}(τ) is a portion of the channel model 145 (e.g., characteristics of the channel) corresponding to the i-th receiving antenna and j-th transmitting antenna (e.g., for the link between these antennas) at time step r. In this example, xⱼ is the input data transmitted by antenna j, and * is a convolution operation.

In an aspect, the simulated output signal 150 generally exhibits the same or similar statistics and characteristics as the output signal 135. In this way, the simulated output signal can be used to drive a variety of configuration decisions for the transmitter 110 and/or receiver 120. For example, the channel model 145 may be used to forecast communication outages or disruptions (e.g., if characteristics of the simulated output signal 150 indicate such disruptions).

Similarly, based on the simulated output signal 150, the transmitter 110 may be reconfigured to ensure improved communications (e.g., to use more robust communication parameters when the simulated output signal 150 indicates significant noise, interference, and the like, while using less robust but higher throughput parameters when the simulated output signal 150 indicates that robust parameters are not needed). In some aspects, the configurations of the transmitter 110 and/or receiver 120 can be adjusted to ensure that the simulated output signal 150 (and, therefore, the actual output signal 135) is as similar to the input signal 130 as possible.

In at least one aspect, the channel model 145 can be deployed directly on the transmitter 110 and/or receiver 120 to simulate the wireless channel. In aspects, these and other solutions can be implemented entirely automatically. That is, because the channel model 145 can be used to simulate the wireless channel 115 rapidly and with little computing resources (e.g., taking less than one millisecond per OFDM symbol in a MIMO signal), the channel model can be used to simulate the channel in near real time, enabling significantly improved automated adjustment of the communication parameters.

### Example Workflow for Training a Generator Model to Enable Wireless Channel Modeling

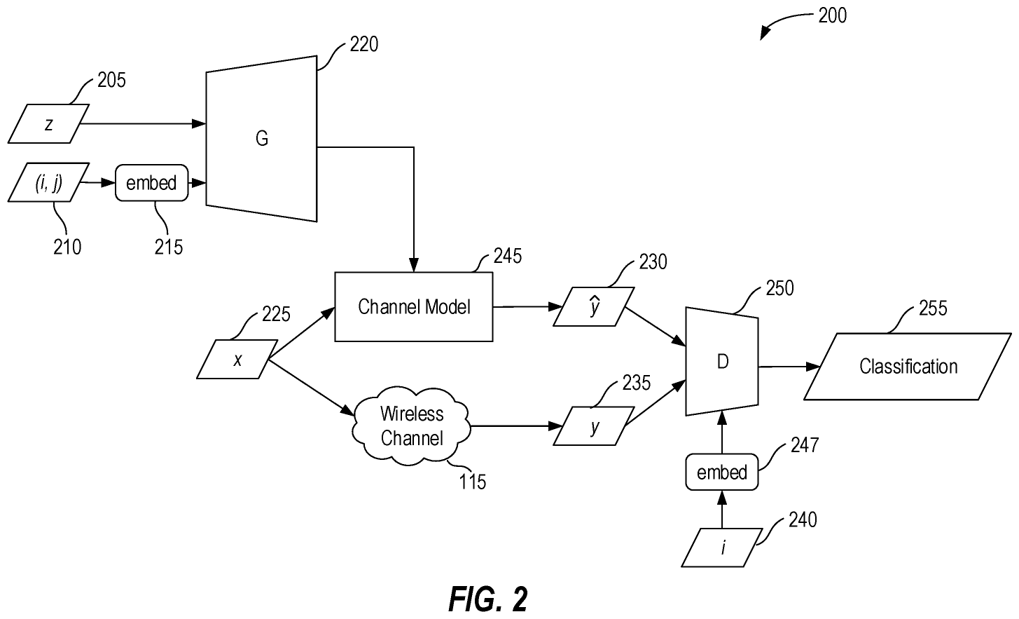

FIG. 2 depicts an example workflow 200 for training a generator model to enable wireless channel modeling. In some aspects, the workflow 200 is performed on a simulation system (e.g., the simulation system 142 of FIG. 1), which may be implemented on the transmitting device, on the receiving device, on a third device such as in the cloud, or on multiple devices.

The illustrated workflow 200 may be used to train a GAN comprising a generator 220 and a discriminator 250. In some aspects, the generator 220 and discriminator 250 each correspond to neural networks. In at least one aspect, the generator 220 corresponds to a multilayer perceptron (MLP) with one or more hidden layers and a nonlinear (e.g., ReLU) activation. In one aspect, the discriminator 250 can similarly be implemented as an MLP with one or more hidden layers and a nonlinear activation.

Generally, the generator component of a GAN can be trained to receive some latent input (e.g., a random vector) and generate some corresponding output that simulates or approximates the target used during training. Stated differently, the generator may be trained to capture the distribution p(x) of some observed data {xᵢ}ᵢ₌₁^{N}, allowing the generator to be used to sample new data points from the distribution. This training may be achieved by leveraging two distinct machine learning models: a generator G: z [symbol] x that transforms an input z (e.g., a random noise vector drawn from a defined distribution) to a sample x (e.g., generator 220), as well as a discriminator D: x [symbol] [0,1] that predicts whether a given sample was generated by G (e.g., that the sample is simulated or fake), or is a sample from the target distribution (e.g., that the sample is a real ground truth sample) (e.g., discriminator 250). The generator 220 and discriminator 250 can generally be trained simultaneously using a min-max objective, discussed in more detail below.

In some examples, the generator 220 can also be conditioned using other input, constraining the generated output based on this condition. In the illustrated example, the generator 220 is trained to generate a channel model 245 (which may correspond to the channel model 145 of FIG. 1). As illustrated, the input to the generator 220 includes a latent input 205 conditioned by a set of antenna indices 210. For example, the latent input 205 many correspond to or be sampled from a defined probability distribution, such as an isotropic multivariate Gaussian distribution. In at least one aspect, the latent input 205 is defined as z˜N(0, I), where I is an identity matrix.

In some aspects, the channel model 245 is defined using a multidimensional tensor, where one dimension (e.g., the width) corresponds to the transmitting elements (e.g., a column for each transmitting antenna), a second dimension (e.g., the height) corresponds to the receiving elements (e.g., a row for each receiving element), and a third dimension (e.g., the depth) corresponds to the link characteristics (e.g., the channel response filter) of each transmitting and receiving antenna pair.

For example, in at least one aspect, the channel model 245 is defined as a three-dimensional tensor H(τ) below, where each element h_{i,j}(τ) is a time-varying complex one-dimensional signal or vector that varies with time r (e.g., time steps based on the time of flight of the signal), and represents the per-link channel response filter between the j-th transmitting antenna and i-th receiving antenna. In some aspects, h_{i,j}(τ) is discretized and represented as a k-dimensional complex vector. Additionally, in the example below, N_{T} represents the number of transmitting antennas, and N_{R} represents the number of receiving antennas.

$$H ( τ ) = ( \begin{matrix}{h}_{1 , 1} ( τ ) & {h}_{1 , 2} ( τ ) & ⋯ & {h}_{1 , {N}_{T}} ( τ ) \\ {h}_{2 , 1} ( τ ) & {h}_{2 , 2} ( τ ) & ⋯ & {h}_{2 , {N}_{T}} ( τ ) \\ ⋮ & ⋮ & ⋱ & ⋮ \\ {h}_{{N}_{R} , 1} ( τ ) & {h}_{{N}_{R} , 2} ( τ ) & ⋯ & {h}_{{N}_{R} , {N}_{T}} ( τ )\end{matrix} )$$

In the workflow 200, the generator 220 is conditioned based on a set of antenna indices 210. Generally, by providing different antenna indices 210, the generator 220 is conditioned to output a portion of the channel model 245 that corresponds to that transmission pathway. For example, if indices (i,j) are provided, then the generator 220 may generate h_{i,j} reflecting the effect of the wireless channel between the j-th transmitting antenna and i-th receiving antenna. In some aspects, these indices can be iteratively specified to generate each corresponding element h_{i,j} in the channel model 245 (sequentially or in parallel).

As illustrated, the antenna indices 210 may first be transformed via an embedding 215 from a set of integers into a vector or tensor before being input to the generator 220. For example, the conditioning coordinates (antenna indices), which may be given as one-hot encodings, can be embedded into a D-dimensional space using a linear neural layer. In an aspect, D is a hyperparameter set by an administrator (e.g., to a value of four in some aspects).

In some aspects of the present disclosure, this conditional generation of channel links based on the embedded link-level (antenna index) information can improve the resulting channel model 245 in a number of ways. For example, as the parameters of the generator 220 are shared for the generation of channels h_{i,j} across all links (i,j), the network is encouraged to learn and exploit correlations between the links. Further, as the input (D-dimensional vectors) and output space (channels h_{i,j}) remains fixed for different MIMO configurations, there is improved parameter efficiency, as the number of parameters in the generator 220 does not change or increase as the number of links change. For example, even in the case of massive MIMO (with a large number of links), conventional systems would use significantly more parameters, not only increasing the latency of using the generator during inferencing, but also rendering training difficult or impossible through significant computational expense. In contrast, the present disclosure can use a significantly smaller number of parameters. Additionally, the same generator 220 can readily be used for different configurations of the transmitter and/or receiver devices.

In some aspects, the channel model 245 can be regenerated (e.g., using a newly sampled latent input 205) using a variety of criteria. That is, a channel model 245 may be generated and used to simulate output data for multiple sets of input data. For example, in some aspects, the simulation system can periodically generate a new channel model 245 by providing a new latent input 205 to the generator 220 (e.g., hourly, daily, and the like). In some aspects, a new channel model 245 can be generated whenever the configuration of the transmitter and/or receiver of the wireless system changes. Similarly, in some aspects, a new channel model 245 can be generated when it is determined that the conditions or characteristics of the wireless channel 115 have changed (e.g., when it is determined that the simulated data is not similar to the actual output data).

As illustrated, a set of input data 225 (e.g., data input to a wireless channel, such as wireless channel 115) can be processed using the channel model 245 to generate the simulated output data 230 (which approximates the actual output data 235 that is output from the wireless channel 115 and received at a receiver). In some aspects, this processing involves convolving the input data 225 with the channel model 245 to generate the simulated output data 230.

In some aspects, the input data 225 may be defined as x=[x₁, . . . , x_{T}_{ᵢₙ}]∈ [symbol] ^{N}^{_{T}}^{×T}^{ᵢₙ}, where Tᵢₙ indicates the number of time steps in the data. Similarly, the simulated output data 230 can be defined as ŷ=[ŷ₁, . . . , ŷ_{T}_{ᵢₙ}]∈ [symbol] ^{N}^{_{R}}^{×T}^{ₒᵤₜ}, and the output data 235 can be represented as y=[y, . . . , y_{T}_{ᵢₙ}]∈ [symbol] ^{N}^{_{R}}^{×T}^{ₒᵤₜ}.

As illustrated, the simulated output data 230 and/or ground truth output data 235 may be processed using the discriminator 250 to generate a classification 255, conditioned on a receiving antenna index 240 (referred to in some aspects as an antenna coordinate). In some aspects, as discussed below in more detail, the simulated output data 230 and/or output data 235 may be supplemented using auto-correlations to introduce global information to the discriminator.

Generally, the discriminator 250 can be used to encourage the generator 220 to produce realistic channel samples (e.g., simulated output data 230) ŷ∈ [symbol] ^{N}^{_{R}}^{×T}^{ₒᵤₜ} that are consistent with the ground truth samples (e.g., output data 235) y∈ [symbol] ^{N}^{_{R}}^{×T}^{ₒᵤₜ} given input (e.g., input data 225) x∈∈ [symbol] ^{T}^{_{R}}^{×T}^{ᵢₙ}. In an aspect, the discriminator 250 does so by learning to identify simulated (e.g., generated) output data 230 and (real, actual, or ground truth) output data 235.

In the illustrated example, in a similar manner to the generator 220, the simulation system can also provide conditional information to the discriminator 250 in the form of embeddings of receiver antenna indices 240, embedded via embedding 247 (e.g., using a linear layer). As a result, the discriminator 250 can learn to discriminate between real and simulated samples of output waveforms y, ŷ∈∈ [symbol] ^{T}^{ₒᵤₜ} conditioned on the receiving antenna.

In some aspects, the discriminator 250 (in a similar manner as the conditional channel generation using generator 220) is spatially conditioned, and can beneficially be used to evaluate data in different MIMO configurations, while the number of parameters in the discriminator 250 remains constant.

In an aspect, to further complement the local (receiver antenna-specific) information observed in the samples (embedded via the conditioning antenna index 240), the simulation system can additionally introduce global information to the discriminator (across all receiving antennas) using an auto-correlation in the form of receiver-side spatial correlations y^{H}y∈∈ [symbol] ^{N}^{_{R}}^{×N}^{_{R}} for the output data 235, and ŷ^{H}ŷ∈∈ [symbol] ^{N}^{_{R}}^{×N}^{_{R}} in the case of the simulated output data 230.

As discussed above, the resulting classification 255 generally classifies the received data as real (e.g., output data 235) or simulated (e.g., simulated output data 230), allowing the generator 220 to be refined to generate more accurate simulated data (via more accurate channel models), while the discriminator simultaneously learns to make more accurate classifications.

In at least one aspect, the generator 220 and discriminator 250 are trained simultaneously using a min-max objective defined in Equation 1 below, where L is the training loss used to refine the generator 220 and discriminator 250, [symbol] _{y} and [symbol] _{z} are the expected value of random variables y and z, respectively drawn from probability distributions p_{data} (e.g., a real data distribution, comprising of collected measurements) and p(z), respectively. Further, x is the input data 225, y is the output data 235, His the channel model 245, D(⋅) represents application of the discriminator 250, z is the latent input 205 (e.g., a random vector sampled from a distribution), p(z) is the Gaussian noise prior discussed above, ŷ is the simulated output data 230, and G(⋅) represents application of the generator 220.

$$L = {min}_{G} {max}_{D} {𝔼}_{y \sim {p}_{data}} [ log D ( y , {y}^{H} y ) ] - {𝔼}_{z \sim p ( z )} [ log ( D ( x * G ( z ) , {\hat{y}}^{H} \hat{y} ) ) ] \qquad Equation 1$$

In at least one aspect, the min-max objective used to train the generator and discriminator networks is defined using Equation 2 below, where L is the training loss used to refine the generator 220 and discriminator 250, [symbol] _{ŷ}, [symbol] _{y}, and [symbol] _{\tilde{y}} are the expected value of random variables ŷ, y, and \tilde{y}, respectively drawn from probability distributions p_{g} (e.g., a distribution of simulated measurements given real input data), p_{data} (e.g., a real data distribution, comprising of collected measurements), and p_{\tilde{y}} (e.g., a distribution of \tilde{y}), respectively. In Equation 2, y is an interpolation between real samples y (e.g., output data) and simulated samples y (e.g., simulated output data 230) according to \tilde{y}=∈y+(1−∈)ŷ, where E is sampled from a uniform distribution Unif according to ∈˜Unif [0,1]. Further, in Equation 2, x is the input data 225, y is the output data 235, H is the channel model 245, D(⋅) represents application of the discriminator 250, ∇_{\tilde{y}} is the gradient operation with respect to \tilde{y}, and λ is the weight or gradient penalty co-efficient, which may be a hyperparameter (e.g., set to a value of 10).

$$L = {min}_{G} {max}_{D} {𝔼}_{\hat{y} \sim {p}_{g}} [ D ( \hat{y} , {\hat{y}}^{H} \tilde{y} ) ] - {𝔼}_{y \sim {p}_{data}} [ D ( y , {y}^{H} y ) ] - λ {𝔼}_{\tilde{y} \sim {p}_{\tilde{y}}} [ {( {‖ {∇}_{\tilde{y}} D ( \tilde{y} , {\tilde{y}}^{H} \tilde{y} ) ‖}_{2} - 1 )}^{2} ] \qquad Equation 2$$

By using the workflow 200, the GAN (e.g., the generator 220 and discriminator 250) can be iteratively trained using sets of wireless measurements (e.g., using a set of input data and a corresponding set of output data). In this way, the generator 220 learns to generate channel models that can be efficiently and rapidly used to simulate the wireless channel.

In some aspects, the simulation system operates on the transmitting device. In others, the simulation system can operate on the receiving device. Additionally, in some aspects each device can serve as both transmitter and receiver, enabling bidirectional communications. In at least one aspect, the simulation system can define some “pilot” input data to be used as ground truth input data for the training workflow 200. This can allow each system to use the defined input data, in conjunction with the system's received output data 235, to perform the workflow 200.

### Example Workflow for Simulating Output Data Using a Channel Model

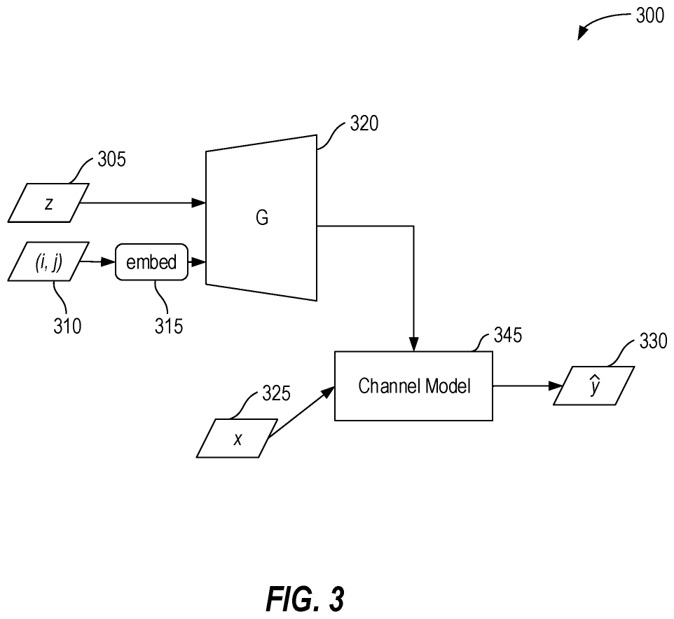

FIG. 3 depicts an example workflow 300 for predicting output data characteristics using a generated channel model 345 (which may correspond to the channel model 145 of FIG. 1 and/or the channel model 245 of FIG. 2). In some aspects, the workflow 300 uses a generator network (e.g., generator 220 of FIG. 2) that was trained using the workflow 200. In some aspects, the workflow 300 is performed on a simulation system (e.g., the simulation system 142 of FIG. 1), which may be implemented on the transmitting device, on the receiving device, on a third device such as in the cloud, or on multiple devices.

As illustrated, in a similar manner to the workflow 200, the generator 320 is configured to receive a latent input 305 (e.g., sampled from a Gaussian distribution) to generate a channel model 345. Further, as discussed above, the output of the generator 320 is conditioned using antenna pairs (e.g., (i,j) pairs, corresponding to a receiving antenna and transmitting antenna, respectively). This can allow the generator 320 to iteratively (in parallel or sequentially) generate each element of the channel model 345 (where each element indicates the channel response for the given link between the j-th and i-th antennas).

In some aspects, the workflow 300 uses the same latent input 305 (e.g., the same random vector sampled from the distribution) to generate all of the elements of the channel model 345. Upon various criteria, the simulation system may sample a new latent input 305 to generate a new channel model 345. For example, as discussed above, the simulation system may periodically regenerate the channel model 345 using new latent input 305, or may do so upon the existence or occurrence of other defined criteria, such as a change in the transmitter or receiver configurations, upon determining that the simulated data no longer aligns with the actual received data, and the like.

In some aspects, the simulation system may learn or select the latent input 305 in order to compactly represent the channel state information, which can aid channel reconstruction. That is, in at least one aspect, the simulation system may seek to identify a value for the latent input that leads to an optimal channel model, rather than randomly generating the latent input 305. For example, the simulation system may determine

$${z}^{*} = arg {min}_{z} d ( y , x * H ( z ) ) ,$$

where z* is a sample from the distribution z and corresponds to a vector that minimizes the differences between the actual output data y and the simulated output data (given as x*H(z)), which is generated by convolving input data x with the channel model H(z). In some aspects, this determined value z* can be used to adapt future input data to improve reliability of the communications. For example, z* may be a real-valued vector that can encode information relating to certain frequencies (e.g., sub-carriers) to avoid when transmitting data in the channel.

Similarly, in at least one aspect, the simulation system may rapidly build channel models 345 to run fast evaluations on the data, in an effort to fine-tune the transmitter and/or receiver parameters (e.g., to down select the configuration parameters). For example, using these fast evaluations, the transmitting system may make various transmission choices prior to transmitting the input data 325 (such as choosing a modulation technique to encode the data, a number of the frequency subcarriers to use, and the like).

In the illustrated workflow 300, using the generated channel model 345, the simulation system can transform the input data 325 (e.g., data transmitted into a wireless channel) into simulated output data 330 (e.g., data received from the wireless channel by a receiver), as discussed above. For example, the input data 325 may be convolved with the channel model 345 to yield the simulated output data 330. As discussed above, this simulated output data 330 can be used for a variety of purposes.

In some aspects, rather than being used to simulate output data, the generator 320 can be used to improve operations of the communication systems, enabling fine-tuning of site-specific aspects of the deployment. For example, as discussed above, the model (or z*) may be used to forecast outages or identify problematic subcarriers at the site where the wireless system is deployed.

Moreover, in the illustrated aspect, the discriminator (not depicted in FIG. 3) may be discarded (or otherwise not used) during simulation. In some aspects, however, the discriminator may be retained for various purposes. For example, in at least one aspect, the discriminator can be used for non-simulation tasks, such as periodically checking the consistency between the simulated output data and the actual output data. For example, under expected operation conditions, the discriminator should output high probability values for actual output data. If this is not the case, then the system may infer that the current channel is in some out-of-distribution (OOD) regime, indicating that the system cannot be confident in the channel model's predictions. In one such aspect, if the simulated data and measured are not sufficiently consistent or similar, then the simulation system may determine to generate a new channel model, refine the GAN, fall back to a default configuration for the transmitter and/or receiver, use an alternative (default) method of channel modeling, and the like.

Similarly, in some aspects, the discriminator can be used to extract features of waveforms (e.g., by using the intermediate features in the penultimate layer of the discriminator). These features can then be used to perform a variety of other tasks, such as out-of-distribution (OOD) classification. In some aspects, particularly for novel tasks for which training data is limited, converting the input data to informative features can be used to significantly improve model performance.

### Example Method for Training a GAN for Improved Channel Modeling

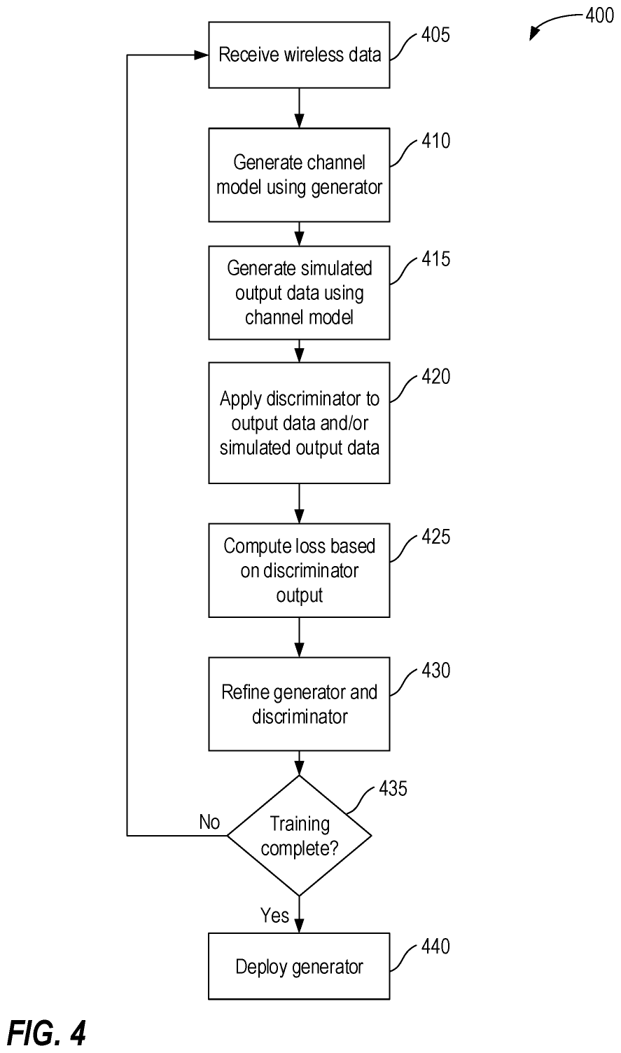

FIG. 4 depicts an example flow diagram illustrating a method 400 for training a generative adversarial network for improved channel modeling. In some aspects, the method 400 is performed by a simulation system (such as the simulation system 142 of FIG. 1, which may be implemented on the transmitting device, on the receiving device, on a third device such as in the cloud, or on multiple devices), as discussed above.

At block 405, the simulation system receives wireless data (e.g., a set of wireless measurements). For example, the wireless data may include input data for a wireless channel (e.g., data that is transmitted, by a transmitter, into the wireless channel) and corresponding output data from the channel (e.g., data that is received, by a receiver, from the wireless channel).

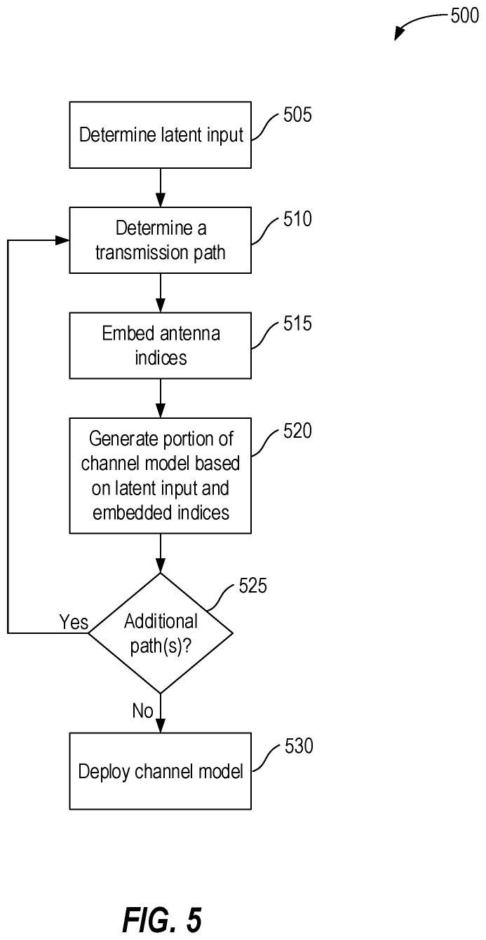

At block 410, the simulation system generates a channel model (e.g., channel model 145 of FIG. 1, channel model 245 of FIG. 2, and/or channel model 345 of FIG. 3) using a generator network (e.g., generator 220 of FIG. 2). For example, as discussed above, the simulation system may sample a random vector from a probability distribution, and use this vector as a seed to generate a channel model (potentially conditioned on an antenna pair), as discussed above. One example of generating a channel model is discussed in more detail below with reference to FIG. 5.

At block 415, the simulation system generates simulated output data using the channel model. For example, as discussed above, the simulation system may convolve the input data with the channel model in order to generate the simulated data. In some aspects, during the training, this simulated output data may differ substantially from the actual output data. For example, the generator network may be initialized with random weights (or with weights pre-trained by one or more other systems), which may result in an output channel model that does not approximate the underlying channel well. However, during training, the generator (and therefore, the resulting channel model) is iteratively improved.

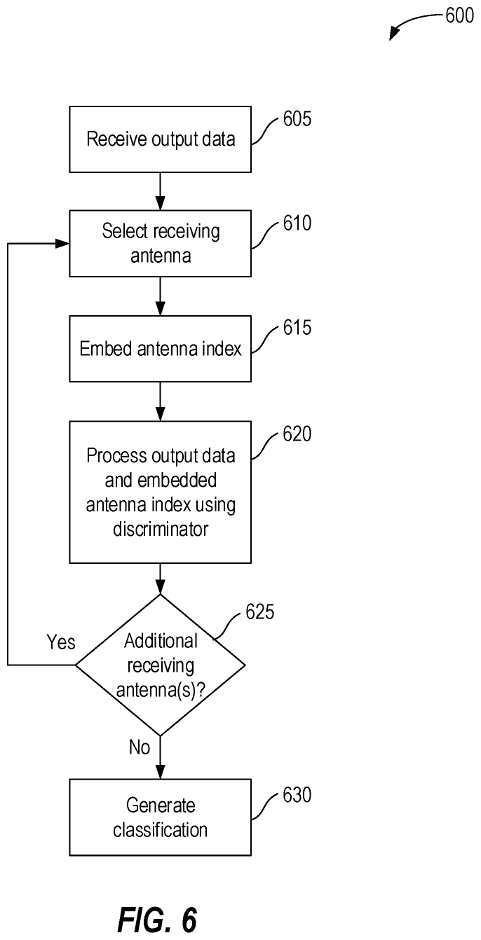

At block 420, the simulation system processes the actual output data, and/or the simulated output data, with a discriminator network (e.g., discriminator 250 of FIG. 2). In some aspects, this includes conditioning the output on an antenna index, as discussed above. As discussed above, the discriminator can generally be trained to classify data as real (e.g., actual output data) or simulated (e.g., generated using a channel model). In a similar manner to the generator, in some aspects, the discriminator may initially perform relatively poorly in this classification task. However, as the training progresses, the discriminator is iteratively improved. One example of processing data using a discriminator is discussed in more detail below with reference to FIG. 6.

At block 425, the simulation system computes a loss based on the discriminator output. In some aspects, as discussed above, the simulation system can compute a min-max loss to jointly train the generator network and discriminator network simultaneously. In at least one aspect, the simulation system uses Equation 1, above, to define the loss.

At block 430, the simulation system can then refine both the generator and discriminator based on this computed loss. Although the illustrated example suggests refining the generator and discriminator individually for each sample of wireless data (e.g., using stochastic gradient descent) for conceptual clarity, in aspects, the simulation system may refine the models based on batches of multiple samples (e.g., using a batch gradient descent).

At block 435, the simulation system determines whether training is complete. In various aspects, this determination may be made based on a wide variety of termination criteria. For example, in one aspect, the simulation system can determine whether additional training data remains to be processed. If so, then training is not complete. In another aspect, the simulation system can determine whether a defined amount of time, a defined amount of computing resources, a defined number of training cycles or epochs, and the like have elapsed. In at least one aspect, the simulation system can determine whether the discriminator's accuracy is within a defined threshold or range from 50% (e.g., indicating that the channel model is sufficiently accurate and the discriminator is effectively randomly guessing whether the output is real or simulated).

If training is not complete, then the method 400 returns to block 405. In some aspects, the simulation system can generate a new channel model for each training round. That is, after the generator is refined during a given training cycle, the generator can be used to generate a new channel model (based on the same latent input, or a new randomly sampled input at block 410).

If training has terminated, then the method 400 continues to block 440, where the simulation system deploys the generator model (e.g., locally, to the transmitter, and the like). As discussed above, the generator can be used to efficiently generate channel models, which can, in turn, be used to quickly (and with minimal computational expense) simulate the effects of a wireless channel on provided input data.

Note that FIG. 4 is just one example of a method, and other methods including fewer, additional, or alternative operations are possible consistent with this disclosure.

### Example Method for Generating a Channel Model Using a Generator Model

FIG. 5 depicts an example flow diagram illustrating a method 500 for generating a channel model using a generator model. In some aspects, the method 500 provides additional detail for block 410 of FIG. 4. Generally, the method 500 may be used during training (e.g., to generate a channel model to produce simulated data during training), as well as during inferencing (e.g., to generate a channel model used to simulate data in deployment). In at least one aspect, the method 500 is performed by a simulation system (such as the simulation system 142 of FIG. 1, which may be implemented on the transmitting device, on the receiving device, on a third device such as in the cloud, or on multiple devices), as discussed above. In some aspects, as discussed above, the generated channel model can generally indicate or predict the effect of the wireless channel on each pathway or link in the wireless channel.

At block 505, the simulation system determines a latent input. In some aspects, as discussed above, determining the latent input can include sampling a random vector from a defined distribution, such as a multivariate isometric Gaussian distribution. In at least one aspect, as discussed above, the number of dimensions (and thus the length of the vector) matches the depth of the tensor representing the channel model.

In some aspects, as discussed above, determining the latent input includes identifying a vector z* that can be used to compactly represent the channel state information. As discussed above, this z* can be used in a variety of ways, including as input to another algorithm or model that determines optimal encoding parameters (such as quadrature amplitude modulation (QAM) type), the optimal number of subcarriers to use, frequencies to avoid, and the like. Further, in some aspects, the system may periodically store channel state information in a conventional state to enable future analysis. By instead storing z*, the system may store this information more compactly, thereby improving storage efficiency.

At block 510, the simulation system determines a transmission path or link (e.g., a pair of antennas, including a transmitting antenna and a receiving antenna). As discussed above, in some aspects, the simulation system conditions the output of the generator on these antenna indices, iteratively building up the entire channel model by generating separate vectors indicating the response and characteristics of each link. Generally, determining the transmission path may be performed according to any suitable criteria, as all transmitter/receiver pairs will be similarly selected and processed.

At block 515, the simulation system embeds the indices of the antennas in the selected transmission path. In at least one aspect, as discussed above, this includes mapping the indices (e.g., in a one-hot vector) to a vector space that matches the dimensionality of the model (e.g., using a linear neural network layer).

At block 520, the simulation system generates a portion of the channel model (e.g., one h_{i,j} element, as discussed above) based on the latent input (determined at block 505) and the embedded indices. As discussed above, the simulation system may do so by seeding the generator network using the latent input, conditioned on the embedded indices.

At block 525, the simulation system determines whether there is at least one additional transmission path or link remaining in the wireless channel. If so, then the method 500 returns to block 510. In the illustrated example, the same latent input is used to generate each element of the channel model. In some aspects, the simulation system may resample latent input (or otherwise determine a new latent input) for each transmission path.

Although the illustrated example depicts a sequential process (processing each link iteratively) for conceptual clarity, in some aspects, the simulation system can process some or all of the antenna pairs (e.g., all of the elements in the channel model) substantially simultaneously (e.g., in parallel). If the simulation system has iterated through all transmission paths, then the method 500 continues to block 530.

At block 530, the simulation system deploys the channel model for use (e.g., locally, on a transmitter, and the like). In some aspects, as discussed above, this use includes combining transmitted input data using the model (e.g., using convolution) to generate simulated output data, which can be used for a variety of purposes. In at least one aspect, as discussed above, the simulation system can deploy the model to improve the communications of a wireless system.

Note that FIG. 5 is just one example of a method, and other methods including fewer, additional, or alternative operations are possible consistent with this disclosure.

### Example Method for Classifying Output Data Using a Discriminator Model

FIG. 6 depicts an example flow diagram illustrating a method 600 for classifying output data using a discriminator model. In some aspects, the method 600 provides additional detail for block 420 of FIG. 4. Generally, the method 600 may be used during training (e.g., to classify data as real or simulated in order to refine the GAN), as well as during inferencing (e.g., to periodically compare the simulated data with the ground truth data, as discussed above). In at least one aspect, the method 600 is performed by a simulation system (such as the simulation system 142 of FIG. 1, which may be implemented on the transmitting device, on the receiving device, on a third device such as in the cloud, or on multiple devices), as discussed above.

At block 605, the simulation system receives or selects output signal data for classification. As discussed above, this output signal may correspond to real signal data (e.g., data received at a receiver after transmission in a wireless channel) or simulated signal data.

At block 610, the simulation system selects a receiving antenna in the wireless system for which classifications are being generated. As discussed above, in some aspects, the discriminator can be conditioned using the index of the receiving antenna, enabling improved spatial awareness.

At block 615, the simulation system embeds the index of the selected antenna, as discussed above (e.g., using a linear layer of a network).

At block 620, the simulation system processes a set of output signal data (which may be real or ground-truth data, or simulated data), conditioned on the selected antenna, using the discriminator. In some aspects, as discussed above, the simulation system can also include auto-correlation (e.g., y^{H}y) along with the output signal, in order to provide enhanced global awareness, of the other links in the wireless channel, for the discriminator (e.g., how each link interacts with each other link).

At block 625, the simulation system can determine whether one or more additional receiving antennas exist in the wireless system. If so, then the method 600 returns to block 610 to select another antenna. Although the illustrated example depicts a sequential operation (processing each receiving antenna separately) for conceptual clarity, in some aspects, the simulation system can process some or all of the antennas substantially simultaneously (e.g., in parallel).

If no additional receiving antennas remain, then the method 600 continues to block 630, where the simulation system generates a classification for the output data based on the processing (performed at block 620) for each antenna. As discussed above, this classification can be used to refine the generator and the discriminator.

Note that FIG. 6 is just one example of a method, and other methods including fewer, additional, or alternative operations are possible consistent with this disclosure.

### Example Method for Simulating Output Data Using a Channel Model

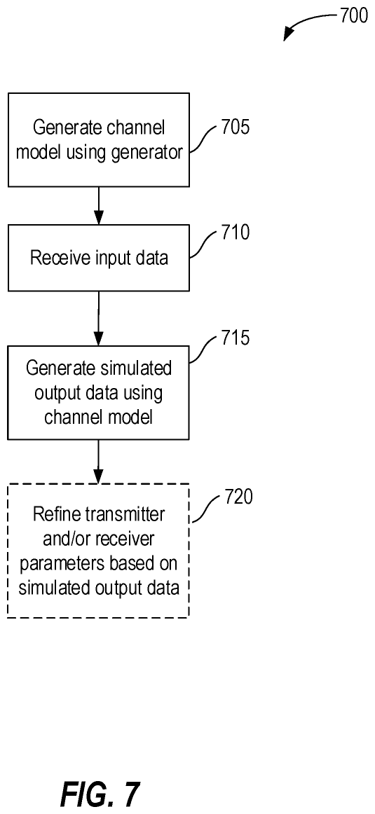

FIG. 7 depicts an example flow diagram illustrating a method 700 for generating simulated output data using a channel model. In some aspects, the method 700 is performed by a simulation system (such as the simulation system 142 of FIG. 1, which may be implemented on the transmitting device, on the receiving device, on a third device such as in the cloud, or on multiple devices), as discussed above. In one aspect, the method 700 corresponds to the workflow 300, discussed above with reference to FIG. 3. The simulation system can generally be performed using a trained generator network (e.g., generator 320 of FIG. 3).

At block 705, the simulation system generates a channel model using a trained generator, as discussed above. For example, using the method 500 of FIG. 5, the simulation system may generate a channel model based on a random or selected input vector to generate the model.

At block 710, the simulation system receives input data. In an aspect, as discussed above, the input data may generally correspond to data (e.g., a set of bits) that have been, are currently being, or will be transmitted along a wireless channel.

At block 715, the simulation system can generate a corresponding simulated output data (e.g., data that approximates what will actually be received at the receiver of the wireless system, which may be modified or transformed based on the characteristics of the channel) by processing the input data using the channel model. For example, as discussed above, the simulation system may convolve the input data and the channel model.

At block 720, the simulation system optionally refines the transmitter parameters and/or the receiver parameters based on this simulated output. For example, in one aspect, if the transmitter and/or received include neural network parameters, then the simulation system can perform gradient descent to fine-tune these parameters with the objective being to minimize the difference between the input and output bits.

Note that FIG. 7 is just one example of a method, and other methods including fewer, additional, or alternative operations are possible consistent with this disclosure.

### Example Method for Generating Simulated Wireless Data Using Machine Learning

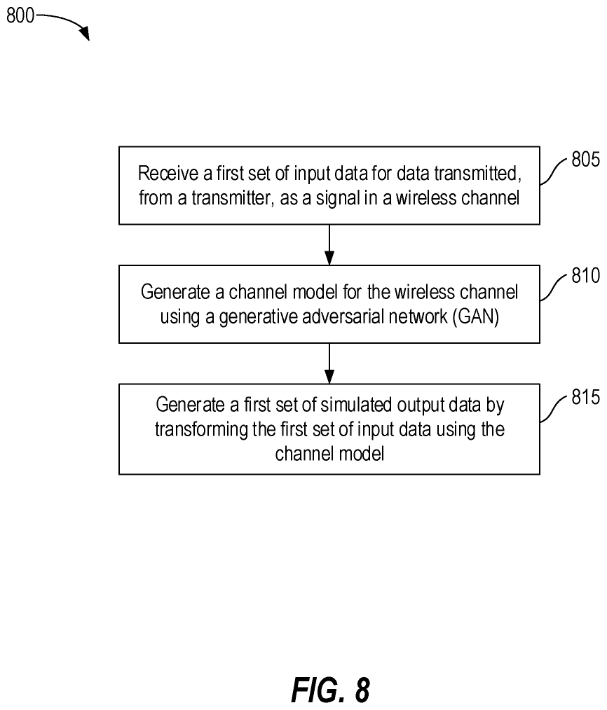

FIG. 8 depicts an example flow diagram illustrating a method 800 for generating simulated wireless data using a machine learning model. In some aspects, the method 800 is performed by a simulation system (such as the simulation system 142 of FIG. 1, which may be implemented on the transmitting device, on the receiving device, on a third device such as in the cloud, or on multiple devices), as discussed above.

At block 805, a first set of input data for data transmitted, from a transmitter, as a signal in a wireless channel, is received.

At block 810, a channel model is generated for the wireless channel using a generative adversarial network (GAN).

In some aspects, the GAN was trained by: training a generator network to generate the channel model, and training a discriminator network to classify output data as real or simulated.

In some aspects, generating the channel model comprises processing latent input, a transmitting antenna index, and a receiving antenna index using the GAN.

In some aspects, the latent input is sampled from a Gaussian distribution according to z˜N(0, I), wherein: z is the latent input, N(⋅) is the Gaussian distribution, and I is an identity matrix.

In some aspects, the latent input represents channel state information and is determined according to

$${z}^{*} = arg {min}_{z} d ( y , x * H ( z ) ) ,$$

wherein: z* is the latent input, d(⋅) is a distance function, y is a set of output data, x is a set of input data, and H(z) is the channel model, generated based on a Gaussian distribution z.

In some aspects, the latent input stores the channel state information in a compact manner and can be used to aid channel reconstruction.

In some aspects, the transmitting antenna index and the receiving antenna index are used to condition the channel model, and wherein, prior to generating the channel model, the transmitting antenna index and receiving antenna index are embedded by transforming them to a vector space.

At block 815, a first set of simulated output data is generated by transforming the first set of input data using the channel model.

In some aspects, the method 800 further includes evaluating model consistency by processing the first set of simulated output data using the discriminator network, and upon determining that the model consistency does not meet defined criteria, refraining from using the channel model.

In some aspects, generating the first set of simulated output data comprises convolving the first set of input data with the channel model.

In some aspects, the method 800 further includes receiving a first set of output data that was received in the wireless channel by a receiver; determining a difference between the first set of simulated output data and the first set of output data; and upon determining that the difference exceeds a defined threshold, using a default configuration for the first transmitter.

Note that FIG. 8 is just one example of a method, and other methods including fewer, additional, or alternative operations are possible consistent with this disclosure.

### Example Method for Training a Machine Learning Model for Wireless Channel Modeling

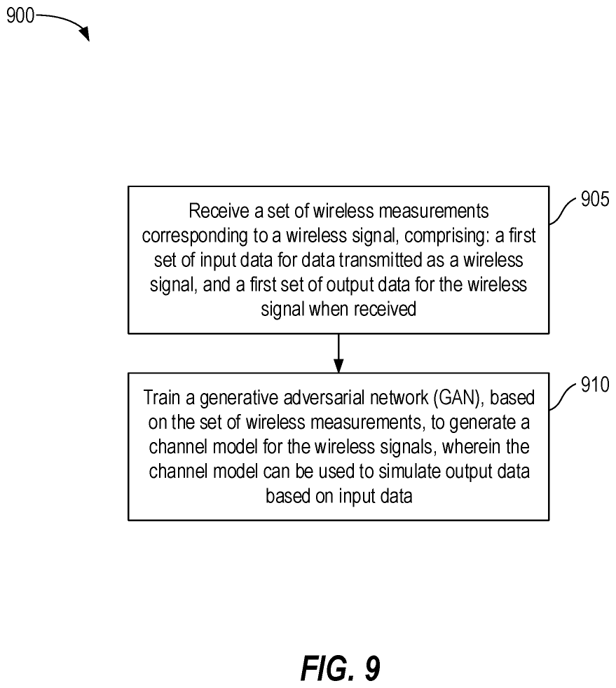

FIG. 9 depicts an example flow diagram illustrating a method 900 for training a machine learning model for channel modeling. In some aspects, the method 900 is performed by a simulation system (such as the simulation system 142 of FIG. 1, which may be implemented on the transmitting device, on the receiving device, on a third device such as in the cloud, or on multiple devices), as discussed above.

At block 905, a set of wireless measurements corresponding to a wireless signal are received, the set of wireless measurements comprising: a first set of input data for data transmitted as a wireless signal; and a first set of output data for the wireless signal when received.

At block 910, a generative adversarial network (GAN) is trained, based on the set of wireless measurements, to generate a channel model for the wireless signals, wherein the channel model can be used to simulate output data based on input data.

In some aspects, the simulated output data are generated by convolving input data with the channel model.

In some aspects, training the GAN comprises: training a generator network to generate the channel model; and training a discriminator network to classify output data as real or simulated.

In some aspects, the discriminator network is trained to classify the output data conditioned on a receiving antenna index.

In some aspects, training the GAN comprises computing a loss L based on a first set of input data and a first set of output data according to

$$L = {min}_{G} {max}_{D} {𝔼}_{x \sim {p}_{d a t a}} [ log D ( x , {y}^{H} y ) ] - {𝔼}_{z \sim p ( z )} [ log ( D ( x * G ( z ) , {\hat{y}}^{H} \hat{y} ) ) ] ,$$

wherein: [symbol] is an expected value of a random variable drawn from a probability distribution, x is the first set of input data, y is the first set of output data, H is the channel model, p_{data} is a data generating distribution, D(⋅) is the discriminator network, z is latent input, p(z) is a Gaussian noise prior, y is simulated output data, and G(⋅) is the generator network.

In some aspects, he generator network is trained to generate the channel model based on a latent input, conditioned based on a transmitting antenna index and a receiving antenna index.

In some aspects, the latent input is sampled from a Gaussian distribution according to z˜N(0, I), wherein: z is the latent input, N(⋅) is the Gaussian distribution, and I is an identity matrix.

In some aspects, the latent input represents channel state information and is determined according to

$${z}^{*} = arg {min}_{z} d ( y , x * H ( z ) ) ,$$

wherein: z* is the latent input, d(⋅) is a distance function, y is a set of output data, x is a set of input measurements, and H(z) is the channel model, generated based on a Gaussian distribution z.

In some aspects, conditioning the generator network based on the transmitting antenna index and receiving antenna index comprises embedding the transmitting antenna index and receiving antenna index by transforming them to a vector space.

In some aspects, the channel model is defined according to

$$H ( τ ) = ( \begin{matrix}{h}_{1 , 1} ( τ ) & {h}_{1 , 2} ( τ ) & ⋯ & {h}_{1 , {N}_{T}} ( τ ) \\ {h}_{2 , 1} ( τ ) & {h}_{2 , 2} ( τ ) & ⋯ & {h}_{2 , {N}_{T}} ( τ ) \\ ⋮ & ⋮ & ⋱ & ⋮ \\ {h}_{{N}_{R} , 1} ( τ ) & {h}_{{N}_{R} , 2} ( τ ) & ⋯ & {h}_{{N}_{R} , {N}_{T}} ( τ )\end{matrix} ) ,$$

wherein: H(τ) is the channel model for a τ-th time step, h_{i,j}(τ) is channel characteristics between an i-th receiving antenna and a j-th transmitting antenna for the i-th time step, N_{T} is a number of transmitting antennas, and N_{R} is a number of receiving antennas.

In some aspects, the channel model is used to generate simulated output data according to: ŷ=Σⱼ₌₁^{N}^{_{T}}(τ)*xⱼ, i=1,2, . . . , N_{R}, wherein: ŷᵢ is simulated output data for receiving antenna i, and xⱼ is input data for transmitting antenna j.

Note that FIG. 9 is just one example of a method, and other methods including fewer, additional, or alternative operations are possible consistent with this disclosure.

### Example Processing System for Wireless Channel Modeling

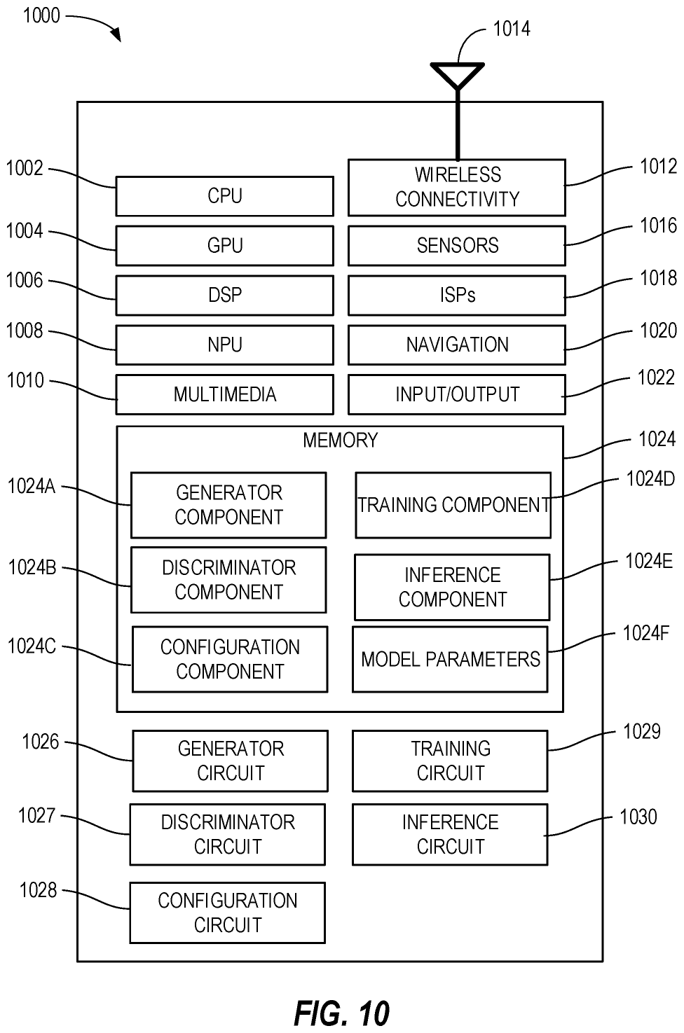

In some aspects, the workflows, techniques, and methods described with reference to FIGS. 1-9 may be implemented on one or more devices or systems. FIG. 10 depicts an example processing system 1000 configured to perform various aspects of the present disclosure, including, for example, the techniques and methods described with respect to FIGS. 1-9. In one aspect, the processing system 1000 may correspond to the simulation system 142 of FIG. 1, as discussed above. In at least some aspects, as discussed above, the operations described below with respect to the processing system may be distributed across any number of devices. For example, one system may train the GAN, while a second uses the generator to generate channel models, and a third uses the models to simulate data.

Processing system 1000 includes a central processing unit (CPU) 1002, which in some examples may be a multi-core CPU. Instructions executed at the CPU 1002 may be loaded, for example, from a program memory associated with the CPU 1002 or may be loaded from a memory 1024.

Processing system 1000 also includes additional processing components tailored to specific functions, such as a graphics processing unit (GPU) 1004, a digital signal processor (DSP) 1006, a neural processing unit (NPU) 1008, a multimedia processing unit 1010, and a wireless connectivity component 1012.

An NPU, such as NPU 1008, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 1008, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In one implementation, NPU 1008 is a part of one or more of CPU 1002, GPU 1004, and/or DSP 1006.

In some examples, wireless connectivity component 1012 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 1012 is further connected to one or more antennas 1014.

Processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

Processing system 1000 may also include one or more input and/or output devices 1022, such as screens, touch-sensitive surfaces (including touch-sensitive displays), physical buttons, speakers, microphones, and the like.

In some examples, one or more of the processors of processing system 1000 may be based on an ARM or RISC-V instruction set.

Processing system 1000 also includes memory 1024, which is representative of one or more static and/or dynamic memories, such as a dynamic random access memory, a flash-based static memory, and the like. In this example, memory 1024 includes computer-executable components, which may be executed by one or more of the aforementioned processors of processing system 1000.

In particular, in this example, memory 1024 includes a generator component 1024A (which may correspond to the generator 220 in FIG. 2 and/or the generator 320 in FIG. 3), a discriminator component 1024B (which may correspond to the discriminator 250 in FIG. 2), a configuration component 1024C, a training component 1024D, and an inference component 1024E. The memory 1024 also includes a set of model parameters 1024F (which may correspond to the parameters of the machine learning models discussed above, such as a generator network and/or a discriminator network). The depicted components, and others not depicted, may be configured to perform various aspects of the techniques described herein. Though depicted as discrete components for conceptual clarity in FIG. 10, generator component 1024A, discriminator component 1024B, configuration component 1024C, training component 1024D, and inference component 1024E may be collectively or individually implemented in various aspects.

Processing system 1000 further comprises generator circuit 1026, discriminator circuit 1027, configuration circuit 1028, training circuit 1029, and inference circuit 1030. The depicted circuits, and others not depicted, may be configured to perform various aspects of the techniques described herein.

For example, generator component 1024A and generator circuit 1026 may be used to generate channel models based on latent input conditioned by antenna embeddings, as discussed above. Discriminator component 1024B and discriminator circuit 1027 may be used to classify data as real or simulated in order to aid training of the models, as discussed above. Configuration component 1024C and configuration circuit 1028 may be used to may be used to modify the transmission parameters of the transmitter and/or receiver based on the simulated data, the generator, and/or the discriminator, as discussed above. Training component 1024D and training circuit 1029 may be used to train, refine, and/or fine-tune the models (e.g., using the workflow 200 in FIG. 2, the method 400 in FIG. 4, and/or the method 900 in FIG. 9), as discussed above. Inference component 1024E and inference circuit 1030 may be used to generate inferences or predictions (e.g., simulated output data) using trained generator models and channel models based on input data (e.g., using the workflow 300 in FIG. 3, the method 700 in FIG. 7, and/or the method 800 in FIG. 8), as discussed above.

Though depicted as separate components and circuits for clarity in FIG. 10, generator circuit 1026, discriminator circuit 1027, configuration circuit 1028, training circuit 1029, and inference circuit 1030 may collectively or individually be implemented in other processing devices of processing system 1000, such as within CPU 1002, GPU 1004, DSP 1006, NPU 1008, and the like.

Generally, processing system 1000 and/or components thereof may be configured to perform the methods described herein.

Notably, in other aspects, aspects of processing system 1000 may be omitted, such as where processing system 1000 is a server computer or the like. For example, multimedia processing unit 1010, wireless connectivity component 1012, sensor processing units 1016, ISPs 1018, and/or navigation processor 1020 may be omitted in other aspects. Further, aspects of processing system 1000 maybe distributed between multiple devices.

### Example Clauses

Clause 1: A method of generating simulated output data, comprising: receiving a first set of input data for data transmitted, from a transmitter, as a signal in a wireless channel; generating a channel model for the wireless channel using a generative adversarial network (GAN); and generating a first set of simulated output data by transforming the first set of input data using the channel model.

Clause 2: The method according to Clause 1, wherein the GAN was trained by: training a generator network to generate the channel model; and training a discriminator network to classify output data as real or simulated.

Clause 3: The method according to Clause 1 or 2, further comprising: evaluating model consistency by processing the first set of simulated output data using the discriminator network; and upon determining that the model consistency does not meet defined criteria, refraining from using the channel model.

Clause 4: The method according to any of Clauses 1-3, wherein generating the channel model comprises processing latent input, a transmitting antenna index, and a receiving antenna index using the GAN.

Clause 5: The method according to any of Clauses 1-4, wherein the latent input is sampled from a Gaussian distribution according to z˜N(0, I), wherein: z is the latent input, N(⋅) is the Gaussian distribution, and I is an identity matrix.

Clause 6: The method according to any of Clauses 1-5, herein the latent input represents channel state information and is determined according to

$${z}^{*} = arg {min}_{z} d ( y , x * H ( z ) ) ,$$

wherein: z* is the latent input, d(⋅) is a distance function, y is a set of output data, x is a set of input data, and H(z) is the channel model, generated based on a Gaussian distribution z.

Clause 7: The method according to any of Clauses 1-6, herein the latent input stores the channel state information in a compact manner and can be used to aid channel reconstruction.

Clause 8: The method according to any of Clauses 1-7, wherein the transmitting antenna index and the receiving antenna index are used to condition the channel model, and wherein, prior to generating the channel model, the transmitting antenna index and receiving antenna index are embedded by transforming them to a vector space.

Clause 9: The method according to any of Clauses 1-8, wherein generating the first set of simulated output data comprises convolving the first set of input data with the channel model.

Clause 10: The method according to any of Clauses 1-9, further comprising modifying one or more transmission parameters of the transmitter based on the first set of simulated output data.

Clause 11: The method according to any of Clauses 1-10, further comprising: receiving a first set of output data that was received in the wireless channel by a receiver; determining a difference between the first set of simulated output data and the first set of output data; and upon determining that the difference exceeds a defined threshold, using a default configuration for the first transmitter.

Clause 12: A method of training a channel model, comprising: receiving a set of wireless measurements corresponding to a wireless signal, comprising: a first set of input data for data transmitted as a wireless signal; and a first set of output data for the wireless signal when received; and training a generative adversarial network (GAN), based on the set of wireless measurements, to generate a channel model for the wireless signals, wherein the channel model can be used to simulate output data based on input data.

Clause 13: The method according to Clause 12, wherein the simulated output data are generated by convolving input data with the channel model.

Clause 14: The method according to Clause 12 or 13, wherein training the GAN comprises: training a generator network to generate the channel model; and training a discriminator network to classify output data as real or simulated.

Clause 15: The method according to any of Clauses 12-14, wherein the discriminator network is trained to classify the output data conditioned on a receiving antenna index.

Clause 16: The method according to any of Clauses 12-15, wherein training the GAN comprises computing a loss L based on a first set of input data and a first set of output data according to

$$L = {min}_{G} {max}_{D} {𝔼}_{x \sim {p}_{d a t a}} [ log D ( x , {y}^{H} y ) ] - {𝔼}_{z \sim p ( z )} [ log ( D ( x * G ( z ) , {\hat{y}}^{H} \hat{y} ) ) ] ,$$

wherein: [symbol] is an expected value of a random variable drawn from a probability distribution, x is the first set of input data, y is the first set of output data, H is the channel model, p_{data} is a data generating distribution, D(⋅) is the discriminator network, z is latent input, p(z) is a Gaussian noise prior, y is simulated output data, and G(⋅) is the generator network.

Clause 17: The method according to any of Clauses 12-16, herein the generator network is trained to generate the channel model based on a latent input, conditioned based on a transmitting antenna index and a receiving antenna index.

Clause 18: The method according to any of Clauses 12-17, wherein the latent input is sampled from a Gaussian distribution according to z˜N(0, I), wherein: z is the latent input, N(⋅) is the Gaussian distribution, and I is an identity matrix.

Clause 19: The method according to any of Clauses 12-18, wherein the latent input represents channel state information and is determined according to

$${z}^{*} = arg {min}_{z} d ( y , x * H ( z ) ) ,$$

wherein: z* is the latent input, d(⋅) is a distance function, y is a set of output data, x is a set of input measurements, and H(z) is the channel model, generated based on a Gaussian distribution z.

Clause 20: The method according to any of Clauses 12-19, wherein conditioning the generator network based on the transmitting antenna index and receiving antenna index comprises embedding the transmitting antenna index and receiving antenna index by transforming them to a vector space.

Clause 21: The method according to any of Clauses 12-20, wherein the channel model is defined according to

$$H ( τ ) = ( \begin{matrix}{h}_{1 , 1} ( τ ) & {h}_{1 , 2} ( τ ) & ⋯ & {h}_{1 , {N}_{T}} ( τ ) \\ {h}_{2 , 1} ( τ ) & {h}_{2 , 2} ( τ ) & ⋯ & {h}_{2 , {N}_{T}} ( τ ) \\ ⋮ & ⋮ & ⋱ & ⋮ \\ {h}_{{N}_{R} , 1} ( τ ) & {h}_{{N}_{R} , 2} ( τ ) & ⋯ & {h}_{{N}_{R} , {N}_{T}} ( τ )\end{matrix} ) ,$$

wherein: H(τ) is the channel model for a τ-th time step, h_{i,j}(τ) is channel characteristics between an i-th receiving antenna and a j-th transmitting antenna for the T-th time step, N_{T} is a number of transmitting antennas, and N_{R} is a number of receiving antennas.

Clause 22: The method according to any of Clauses 12-21, wherein the channel model is used to generate simulated output data according to: ŷᵢ=Σⱼ₌₁^{N}^{_{T}}h_{t,j}(τ)*xⱼ, i=1,2, . . . , N_{R}, wherein: ŷᵢ is simulated output data for receiving antenna i, and xⱼ is input data for transmitting antenna j.

Clause 23: A system, comprising: a memory comprising computer-executable instructions; and one or more processors configured to execute the computer-executable instructions and cause the processing system to perform a method in accordance with any of Clauses 1-22.

Clause 24: A system, comprising means for performing a method in accordance with any of Clauses 1-22.

Clause 25: A non-transitory computer-readable medium comprising computer-executable instructions that, when executed by one or more processors of a processing system, cause the processing system to perform a method in accordance with any of Clauses 1-22.

Clause 26: A computer program product embodied on a computer-readable storage medium comprising code for performing a method in accordance with any of Clauses 1-22.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method of generating simulated output data, comprising:
receiving a first set of input data for data transmitted, from a transmitter, as a signal in a wireless channel;
generating a channel model for the wireless channel using a generative adversarial network (GAN); and
generating a first set of simulated output data by transforming the first set of input data using the channel model.

2. The method of claim 1, wherein the GAN was trained by:
training a generator network to generate the channel model; and
training a discriminator network to classify output data as real or simulated.

3. The processor-implemented method of claim 2, further comprising:
evaluating model consistency by processing the first set of simulated output data using the discriminator network; and
upon determining that the model consistency does not meet defined criteria, refraining from using the channel model.

4. The processor-implemented method of claim 1, wherein generating the channel model comprises processing latent input, a transmitting antenna index, and a receiving antenna index using the GAN.

5. The processor-implemented method of claim 4, wherein the latent input is sampled from a Gaussian distribution.

6. The processor-implemented method of claim 4, wherein the latent input represents channel state information.

7. The processor-implemented method of claim 6, wherein the latent input stores the channel state information in a compact manner and can be used to aid channel reconstruction.

8. The processor-implemented method of claim 4, wherein the transmitting antenna index and the receiving antenna index are used to condition the channel model, and wherein, prior to generating the channel model, the transmitting antenna index and receiving antenna index are embedded by transforming them to a vector space.

9. The processor-implemented method of claim 1, wherein generating the first set of simulated output data comprises convolving the first set of input data with the channel model.

10. The processor-implemented method of claim 1, further comprising modifying one or more transmission parameters of the transmitter based on the first set of simulated output data.

11. The processor-implemented method of claim 1, further comprising:
receiving a first set of output data that was received in the wireless channel by a receiver;
determining a difference between the first set of simulated output data and the first set of output data; and
upon determining that the difference exceeds a defined threshold, using a default configuration for the transmitter.

12. A processor-implemented method of training a channel model, comprising:
receiving a set of wireless measurements corresponding to a wireless signal, the set of wireless measurements comprising:
a first set of input data for data transmitted as a wireless signal; and
a first set of output data for the wireless signal when received; and
training a generative adversarial network (GAN), based on the set of wireless measurements, to generate a channel model for the wireless signals, wherein the channel model can be used to simulate output data based on input data.

13. The processor-implemented method of claim 12, wherein the simulated output data are generated by convolving input data with the channel model.

14. The processor-implemented method of claim 12, wherein training the GAN comprises:
training a generator network to generate the channel model; and
training a discriminator network to classify output data as real or simulated.

15. The processor-implemented method of claim 14, wherein the discriminator network is trained to classify the output data conditioned on a receiving antenna index.

16. The processor-implemented method of claim 14, wherein the generator network is trained to generate the channel model based on a latent input, conditioned based on a transmitting antenna index and a receiving antenna index.

17. The processor-implemented method of claim 16, wherein the latent input is sampled from a Gaussian distribution.

18. The processor-implemented method of claim 16, wherein the latent input represents channel state information.

19. The processor-implemented method of claim 16, wherein conditioning the generator network based on the transmitting antenna index and receiving antenna index comprises embedding the transmitting antenna index and receiving antenna index by transforming them to a vector space.

20. A processing system, comprising:
a memory comprising computer-executable instructions; and
one or more processors configured to execute the computer-executable instructions and cause the processing system to perform an operation comprising:
receiving a first set of input data for data transmitted, from a transmitter, as a signal in a wireless channel;
generating a channel model for the wireless channel using a generative adversarial network (GAN); and
generating a first set of simulated output data by transforming the first set of input data using the channel model.

21. The processing system of claim 20, wherein the GAN was trained by:
training a generator network to generate the channel model; and
training a discriminator network to classify output data as real or simulated.

22. The processing system of claim 21, the operation further comprising:
evaluating model consistency by processing the first set of simulated output data using the discriminator network; and
upon determining that the model consistency does not meet defined criteria, refraining from using the channel model.

23. The processing system of claim 20, wherein generating the channel model comprises processing latent input, a transmitting antenna index, and a receiving antenna index using the GAN.

24. The processing system of claim 23, wherein the latent input is sampled from a Gaussian distribution.

25. The processing system of claim 23, wherein the latent input represents channel state information.

26. The processing system of claim 25, wherein the latent input stores the channel state information in a compact manner and can be used to aid channel reconstruction.

27. The processing system of claim 23, wherein the transmitting antenna index and the receiving antenna index are used to condition the channel model, and wherein, prior to generating the channel model, the transmitting antenna index and receiving antenna index are embedded by transforming them to a vector space.

28. The processing system of claim 20, wherein generating the first set of simulated output data comprises convolving the first set of input data with the channel model.

29. The processing system of claim 20, the operation further comprising modifying one or more transmission parameters of the transmitter based on the first set of simulated output data.

30. A processing system, comprising:
means for receiving a first set of input data for data transmitted, from a transmitter, as a signal in a wireless channel;
means for generating a channel model for the wireless channel using a generative adversarial network (GAN); and
means for generating a first set of simulated output data by transforming the first set of input data using the channel model.
